(19) United States
(12) Patent Application Publication
(10) Pub. No.: US 2011/0073652 A1
(43) Pub. Date: Mar. 31, 2011

(54) METHOD AND APPARATUS FOR INTELLIGENTLY CONTROLLING ILLUMINATION PATTERNS PROJECTED FROM BARCODE READERS

(76) Inventors: Igor VINOGRADOV, New York, NY (US); Edward BARKAN, Miller Place, NY (US); Mark DRYZMALA, Commack, NY (US)

(21) Appl. No.: 12/570,059

(22) Filed: Sep. 30, 2009

(51) Int. Cl. G06K 7/10; H04N 5/225

(52) U.S. Cl. 235/462.08; 348/374; 348/E05.024

(57) ABSTRACT

A method and apparatus for intelligently controlling illumination patterns projected from barcode readers. The method includes (1) detecting a location of an object of interest with a plurality of object sensors each having a corresponding object field of view; and (2) selecting at least one illumination light source to project one or more illumination patterns in one or more predetermined directions at least based upon the location of the object determined with the plurality of object sensors.

### FIELD OF THE DISCLOSURE

The present invention relates to imaging-based barcode readers.

### BACKGROUND

Various electro-optical systems have been developed for reading optical indicia, such as bar codes. A bar code is a coded pattern of graphical indicia comprised of a series of bars and spaces of varying widths, the bars and spaces having differing light reflecting characteristics. The pattern of the bars and spaces encode information. Bar code may be one dimensional (e.g., UPC bar code) or two dimensional (e.g., DataMatrix bar code). Systems that read, that is, image and decode bar codes employing imaging camera systems are typically referred to as imaging-based bar code readers or bar code scanners.

Imaging-based bar code readers may be portable or stationary. A portable bar code reader is one that is adapted to be held in a user's hand and moved with respect to a target indicia, such as a target bar code, to be read, that is, imaged and decoded. Stationary bar code readers are mounted in a fixed position, for example, relative to a point-of-sales counter. Target objects, e.g., a product package that includes a target bar code, are moved or swiped past one of the one or more transparent windows and thereby pass within a field of view of the stationary bar code readers. The bar code reader typically provides an audible and/or visual signal to indicate the target bar code has been successfully imaged and decoded. Sometimes barcodes are presented, as opposed to be swiped. This typically happens when the swiped barcode failed to scan, so the operator tries a second time to scan it. Alternately, presentation is done by inexperience users, such as when the reader is installed in a self check out installation.

A typical example where a stationary imaging-based bar code reader would be utilized includes a point of sale counter/cash register where customers pay for their purchases. The reader is typically enclosed in a housing that is installed in the counter and normally includes a vertically oriented transparent window and/or a horizontally oriented transparent window, either of which may be used for reading the target bar code affixed to the target object, i.e., the product or product packaging for the product having the target bar code imprinted or affixed to it. The sales person (or customer in the case of self-service check out) sequentially presents each target object's bar code either to the vertically oriented window or the horizontally oriented window, whichever is more convenient given the specific size and shape of the target object and the position of the bar code on the target object.

A stationary imaging-based bar code reader that has a plurality of imaging cameras can be referred to as a multi-camera imaging-based scanner or bar code reader. In a multi-camera imaging reader, each imaging camera is operative to capture an image from a predetermined field of view. The multi-camera imaging reader generally also includes one or more illumination light sources operative to project illumination patterns in a plurality of predetermined directions. The light intensities of these illumination patterns can be very bright. In certain circumstances, people positioned near the multi-camera imaging reader can be exposed to such bright light. Some people may consider the bright light annoying and bothersome. Some people may perceive the bright light as dangerous. Accordingly, it is desirable to find an intelligent method to minimize user exposures to the bright light projected from the multi-camera imaging reader.

### SUMMARY

In one aspect, an apparatus includes a housing, an imaging system, an illumination system, a plurality of object sensors, and electronic circuitry for selectively turning on one or more of the illumination patterns. The housing includes one or more transparent windows and defines a housing interior region. The imaging system includes one or more solid-state imagers, located within the housing interior region, operative to capture light from a plurality of predetermined fields of view. The illumination system includes a plurality of illumination light sources operative to project illumination patterns in a plurality of predetermined directions. Each object sensor is operative to detect the presence of the object within a corresponding object field of view, and the plurality of object sensors is operative to detect a location of an object. The electronic circuitry is operative to turn on one or more of the illumination patterns in one or more predetermined directions at least based upon the location of the object obtained with the plurality of object sensors.

In another aspect, a method includes (1) detecting a location of an object with a plurality of object sensors each having a corresponding object field of view; (2) selecting at least one illumination light source to project one or more illumination patterns in one or more predetermined directions at least based upon the location of the object obtained with the plurality of object sensors; (3) capturing light reflected from a barcode on the object with an imaging system that includes one or more solid-state imagers located within an interior region of a housing having one or more transparent windows; and (4) processing an image captured by at least one of the solid-state imagers in the imaging system.

Implementations of the invention can include one or more of the following advantages. The chances of exposing people near the workstation to the bright light projected from the workstation can be reduced. People are less likely to be offended by the bright light projected from the workstation. These and other advantages of the present invention will become apparent to those skilled in the art upon a reading of the following specification of the invention and a study of the several figures of the drawings.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts a workstation in accordance with some embodiments.

FIG. 2 is a schematic of a bi-optical workstation that includes a plurality of solid-state imagers in accordance with some embodiments.

FIGS. 3A-3D are schematics of a bi-optical workstation that has four solid-state imagers in accordance with some embodiments.

FIG. 4A shows a group of other optical components associated the solid-state imager C1 in FIG. 3A in accordance with some embodiments.

FIGS. 5A-5D depict a plurality of illumination patterns with the solid-state imagers in accordance with some embodiments.

FIG. 6 shows that the illumination patterns are projected out of the workstation simultaneously in multiple predetermined directions in accordance with some embodiments.

FIG. 7 depicts a workstation that includes two object sensors S1 and S2 in accordance with some embodiments.

FIGS. 8A-8B and 9A-9B illustrate that the object sensors S1 and S2 can be used to measure the location of an object and such location can be used by the workstation to selectively turn on one or more of the illumination patterns in one or more predetermined directions.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

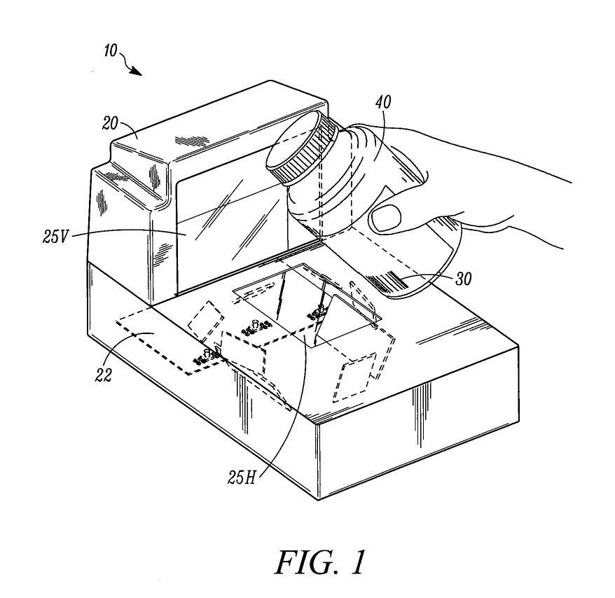

FIG. 1 depicts a workstation 10 in accordance with some embodiments. The workstation 10 is stationary and includes a housing 20. The housing 20 has a generally horizontal window 25H and a generally vertical window 25V. In one implementing, the housing 20 can be integrated into the sales counter of a point-of-transaction system. The point-of-transaction system can also includes a cash register, a touch screen visual display, a printer for generating sales receipts, or other type user interface. The workstation 10 can be used by retailers to process transactions involving the purchase of products bearing an identifying target, such as UPC symbols.

In accordance with one use, either a sales person or a customer will present a product or target object 40 selected for purchase to the housing 20. More particularly, a target bar code 30 imprinted or affixed to the target object will be presented in a region near the windows 25H and 25V for reading, that is, imaging and decoding of the coded indicia of the target bar code. Upon a successful reading of the target bar code, a visual and/or audible signal will be generated by the workstation 10 to indicate to the user that the target bar code 30 has been successfully imaged and decoded.

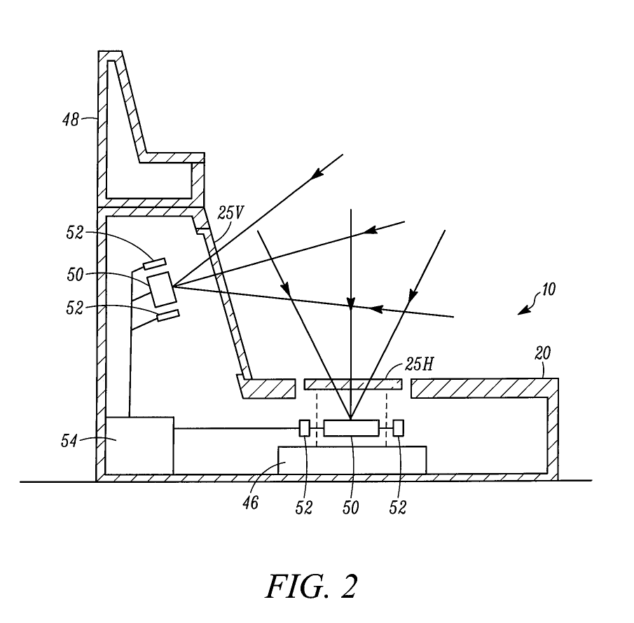

As schematically shown in FIG. 2, a plurality of solid-state imagers 50, each including an illuminator 52, are mounted at the workstation 10, for capturing light passing through either or both windows from a target which can be a one- or two-dimensional symbol, such as a two-dimensional symbol on a driver's license, or any document, as described below. Each imager 50 is a solid-state area array, preferably a CCD or CMOS array. The imagers 50 and their associated illuminators 52 are operatively connected to a programmed microprocessor or controller 54 operative for controlling the operation of these and other components. Preferably, the microprocessor is the same as the one used for decoding the return light scattered from the target and for processing the captured target images.

In operation, the microprocessor 54 sends successive command signals to the illuminators 52 to pulse the LEDs for a short time period of 100 microseconds or less, and successively energizes the imagers 50 to collect light from a target only during said time period, also known as the exposure time period. By acquiring a target image during this brief time period, the image of the target is not excessively blurred.

As previously stated, FIG. 2 is only a schematic representation of an all imager-based workstation as embodied in a bi-optical workstation with two windows. The workstation can have other kinds of housings with different shapes. The workstation can have one window, two windows, or with more than two windows. In some embodiments, the workstation can include between three to six solid-state imagers. The bi-optical workstation can also include more than six solid-state imagers.

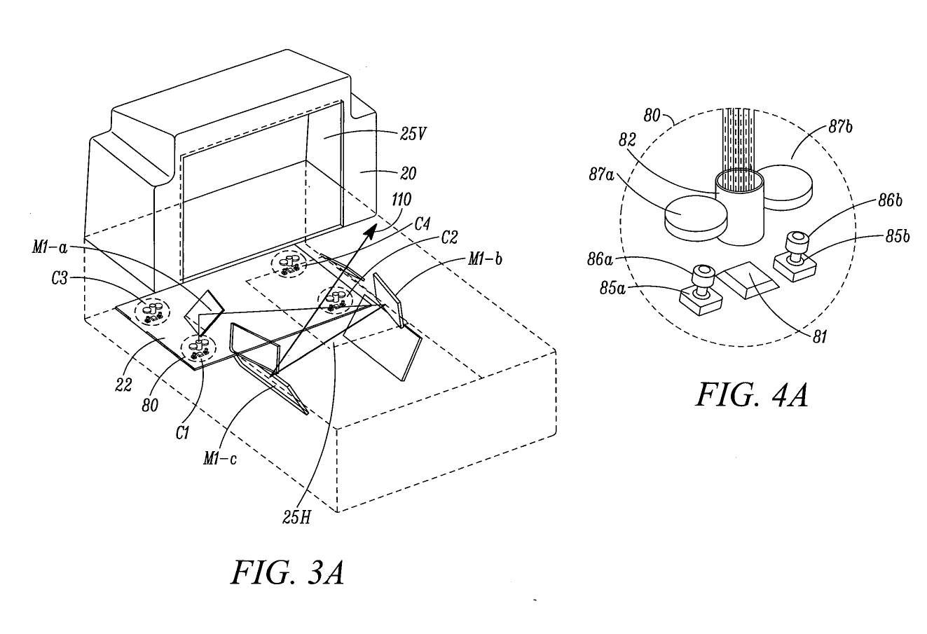

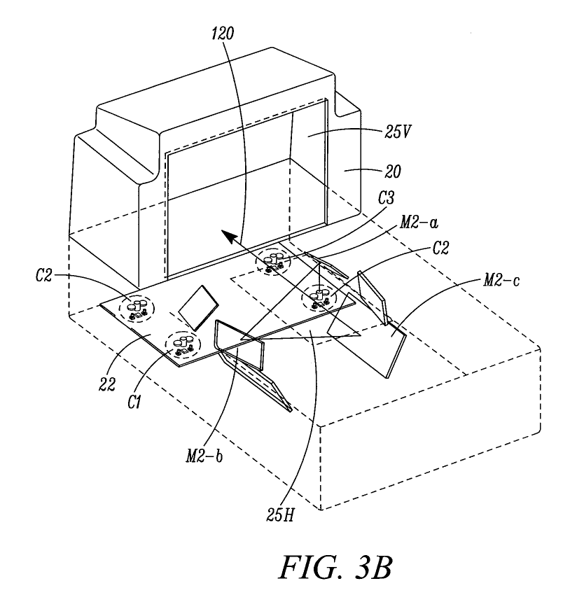

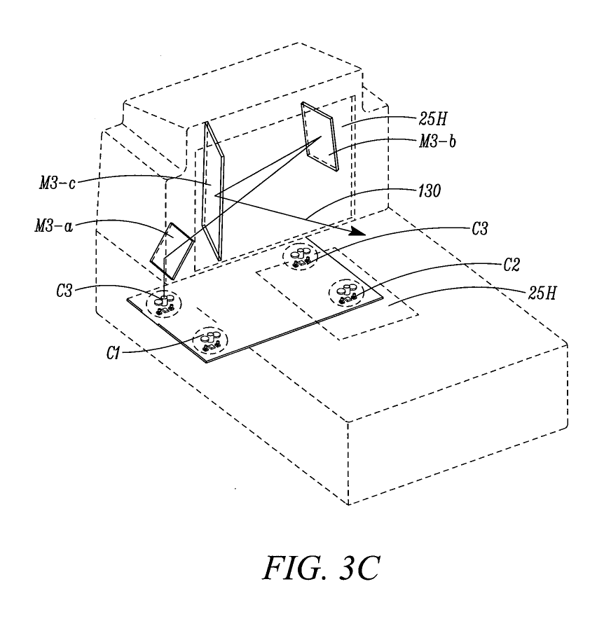

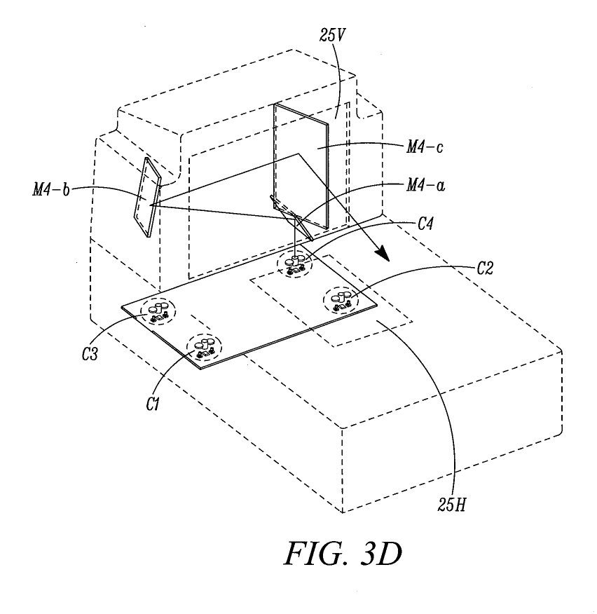

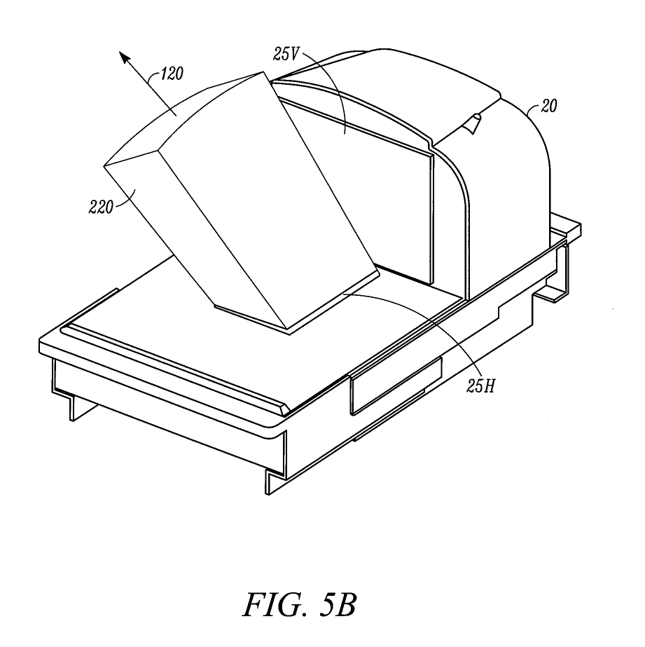

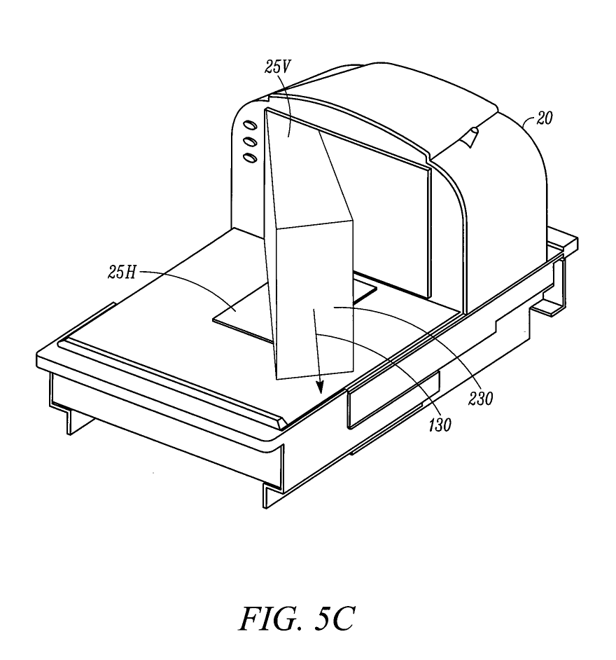

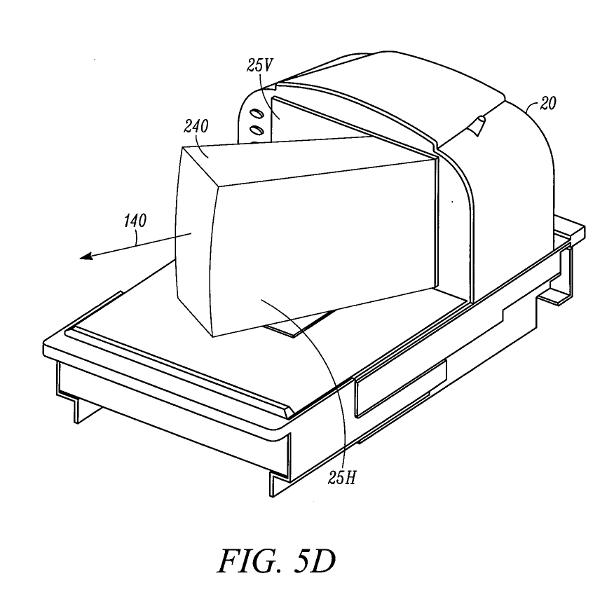

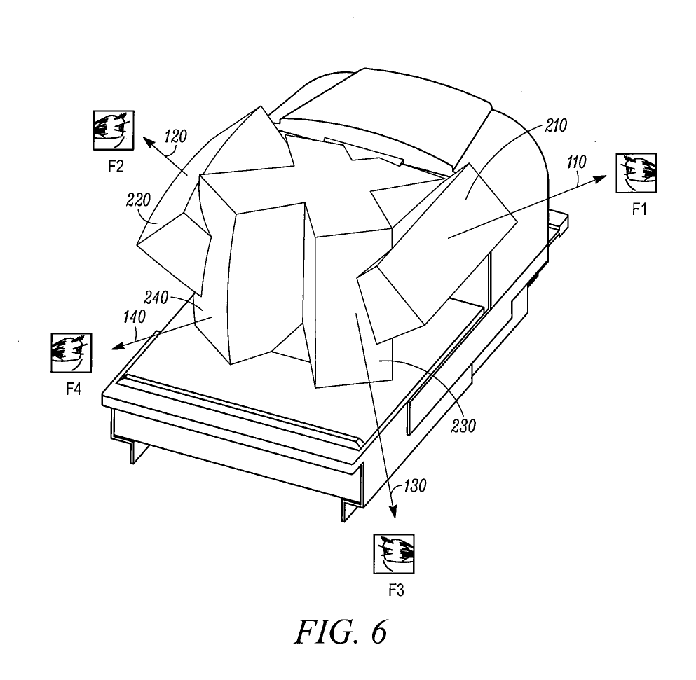

FIGS. 3A-3D are schematics of a bi-optical workstation that has four solid-state imagers in accordance with some embodiments. In FIGS. 3A-3D, the bi-optical workstation includes four solid-state imagers C1, C2, C3, and C4 commonly mounted on a printed circuit board 22. The printed circuit board 22 lies in a generally horizontal plane generally parallel to, and below, the generally horizontal window 25H. FIGS. 5A-5D depict a first illumination pattern 210, a second illumination pattern 220, a third illumination pattern 230, and a fourth illumination pattern 240 that are respectively associated with solid-state imagers C1, C2, C3, and C4.

As shown in FIG. 3A, the solid-state imager C1 faces generally vertically upward toward an inclined folding mirror M1-a directly overhead at the left side of the horizontal window 25H. The folding mirror M1-a faces another inclined narrow folding mirror M1-b located at the right side of the horizontal window 25H. The folding mirror M1-b faces still another inclined wide folding mirror M1-c adjacent the mirror M1-a. The folding mirror M1-c faces out through the generally horizontal window 25H toward the right side of the workstation.

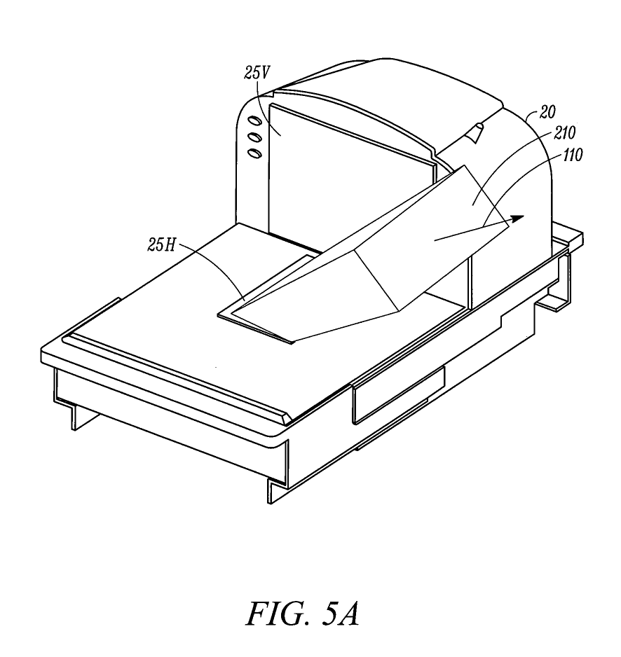

In FIG. 3A, it is shown that the solid-state imager C1 is also associated with a group of other optical components 80. FIG. 4A shows the group of other optical components 80 in details. In FIG. 4A, it is shown that the solid-state imager C1 includes a sensor array 81 and an imaging lens 82. It is also shown that two light emitting diodes 85a and 85b, spaced apart, are installed closely adjacent to the sensor array 81. When the light emitting diode 85a (or 85b) is energized, light emitted from the light emitting diode 85a (or 85b) passes through a light pipe 86a (or 86b) and a lens 87a (or 87b). As shown in FIG. 3A, light emitted from the light emitting diode 85a (or 85b), after bouncing off the folding mirrors M1-a, M1-b, and M1-c sequentially, exits the housing 20 as the first illumination pattern 210 centered by the light ray 110. FIG. 5A shows that the first illumination pattern 210 centered by the light ray 110 exits the housing 20 in a first predetermined direction.

In FIG. 3A, the folding mirrors M1-a, M1-b, and M1-c also constitute part of an optical system for defining a predetermined field of view for the solid-state imager C1. Similar to the first illumination pattern 210 in FIG. 5A, the predetermined field of view for the solid-state imager C1 generally is also centered by the light ray 110. In addition, the predetermined field of view for the solid-state imager C1 is preferably within the first illumination pattern 210 as shown in FIG. 5A.

FIG. 3B and FIG. 5B depict respectively the optical path for the solid-state imager C2 and the second illumination pattern 220 associated with the solid-state imager C2. The solid-state imager C2 and its associated optics in FIG. 3B is mirror symmetrical to the solid-state imager C1 and its associated optics in FIG. 3A. As shown in FIG. 3B, the solid-state imager C2 faces generally vertically upward toward an inclined folding mirror M2-a directly overhead at the right side of the horizontal window 25H. The folding mirror M2-a faces another inclined narrow folding mirror M2-b located at the left side of the horizontal window 25H. The folding mirror M2-b faces still another inclined wide folding mirror M2-c adjacent the mirror M2-a. The folding mirror M2-c faces out through the generally horizontal window 25H toward the left side of the workstation.

In FIG. 3B, when a light emitting diode associated with solid-state imager C2 is energized, light emitted from such light emitting diode, after bouncing off the folding mirrors M2-a, M2-b, and M2-c sequentially, exits the housing 20 as the second illumination pattern 220 centered by the light ray 120. FIG. 5B shows that the second illumination pattern 220 centered by the light ray 120 exits the housing 20 in a second predetermined direction.

FIG. 3C and FIG. 5C depict respectively the optical path for the solid-state imager C3 and the third illumination pattern 230 associated with the solid-state imager C3. In FIG. 3C, the solid-state imager C3 faces generally vertically upward toward an inclined folding mirror M3-a directly overhead at the left side of the vertical window 25V. The folding mirror M3-a faces another inclined narrow folding mirror M3-b located at the right side of the vertical window 25V. The folding mirror M3-b faces still another inclined wide folding mirror M3-c adjacent the mirror M3-a. The folding mirror M3-c faces out through the generally vertical window 25V toward the right side of the workstation.

In FIG. 3C, when a light emitting diode associated with solid-state imager C3 is energized, light emitted from such light emitting diode, after bouncing off the folding mirrors M3-a, M3-b, and M3-c sequentially, exits the housing 20 as the third illumination pattern 230 centered by the light ray 130. FIG. 5C shows that the third illumination pattern 230 centered by the light ray 130 exits the housing 20 in a third predetermined direction.

FIG. 3D and FIG. 5D depict respectively the optical path for the solid-state imager C4 and the fourth illumination pattern 240 associated with the solid-state imager C4. The solid-state imager C4 and its associated optics in FIG. 3D is mirror symmetrical to the solid-state imager C3 and its associated optics in FIG. 3C. In FIG. 3D, the solid-state imager C4 faces generally vertically upward toward an inclined folding mirror M4-a directly overhead at the right side of the vertical window 25V. The folding mirror M4-a faces another inclined narrow folding mirror M4-b located at the left side of the vertical window 25V. The folding mirror M4-b faces still another inclined wide folding mirror M4-c adjacent the mirror M4-a. The folding mirror M4-c faces out through the generally vertical window 25V toward the left side of the workstation.

In FIG. 3D, when a light emitting diode associated with solid-state imager C4 is energized, light emitted from such light emitting diode, after bouncing off the folding mirrors M4-a, M4-b, and M4-c sequentially, exits the housing 20 as the fourth illumination pattern 240 centered by the light ray 140. FIG. 5D shows that the fourth illumination pattern 240 centered by the light ray 140 exits the housing 20 in a forth predetermined direction.

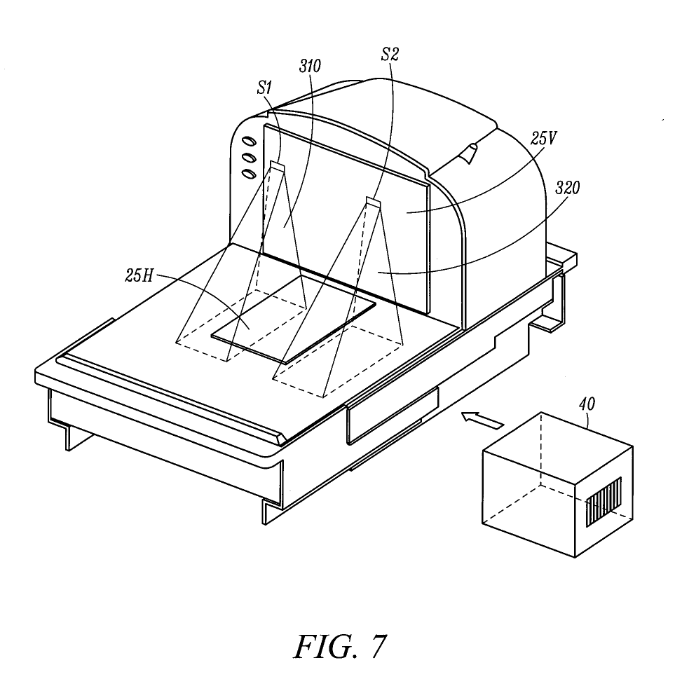

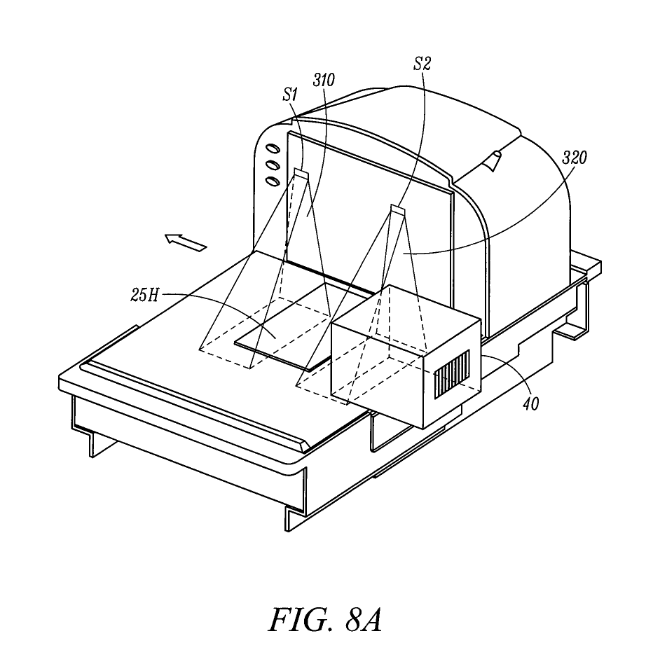

In some of the existing designs of the workstation, as shown in FIG. 6, the illumination patterns 210, 220, 230, and 240 are projected out of the workstation simultaneously or in rapid sequence in multiple predetermined directions. The light intensities of these illumination patterns can be very bright. A person located in front of the horizontal window or the vertical windows can be exposed to such bright light if looked directly towards these windows. For example, when a casher sits in front of a full-service workstation or when a short person (e.g., a child) stands at a self-checkout workstation, this person may subject his/her eyes to direct exposure of the bright light, because his/her face may be located at the same level as the scanner vertical window. Specifically, as shown in FIG. 6, face F3 can be exposed to the bright light of the third illumination pattern 230 and face F4 can be exposed to the bright light of the fourth illumination pattern 240. The person exposed to the bright light may consider such light annoying and bothersome. Some people may perceive the bright light as dangerous even the bright light is reasonably safe and it has satisfied the requirement of all relevant regulatory codes. It is desirable to find an intelligent method to minimize user exposures to the bright light projected from the workstation. One implementation of such intelligent method is illustrated in FIGS. 7, 8A-8B, and 9A-9B.

FIG. 7 depicts a workstation that includes two object sensors S1 and S2. Each object sensor is associated with a corresponding object field of view. Each object sensor is operative to detect the presence of an object within the corresponding field of view of the object sensor. As shown in FIG. 7, the object sensor S1 is associated with a object field of view 310, and the object sensor S2 is associated with a object field of view 320.

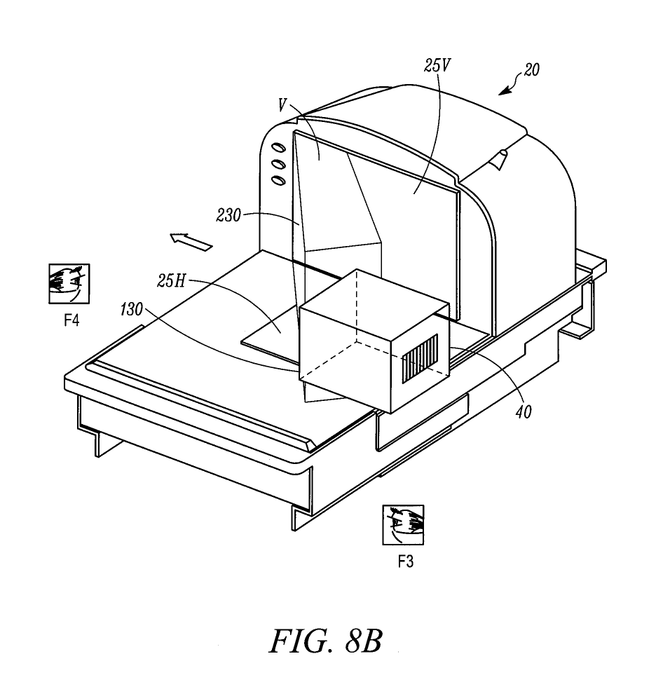

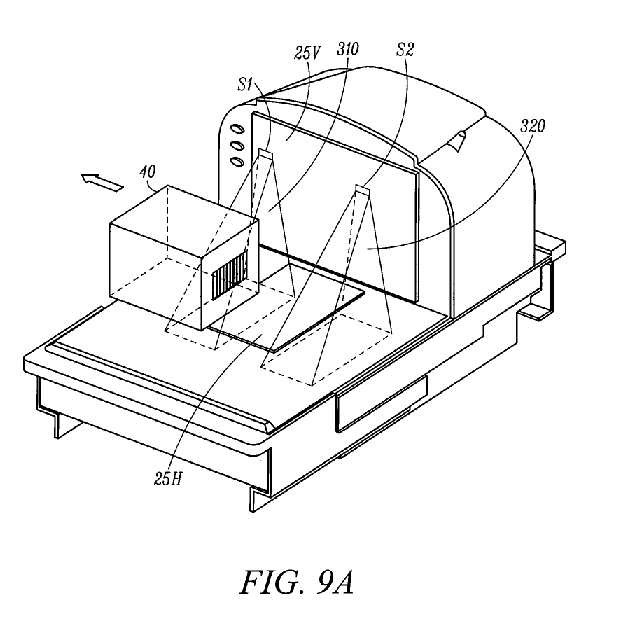

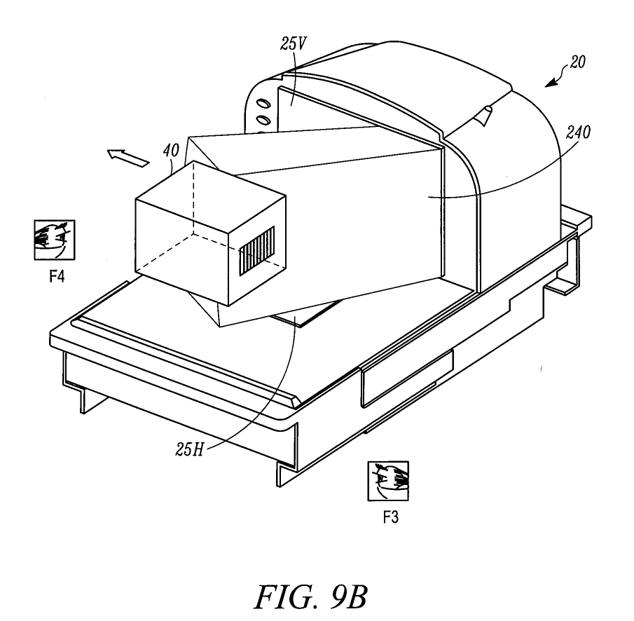

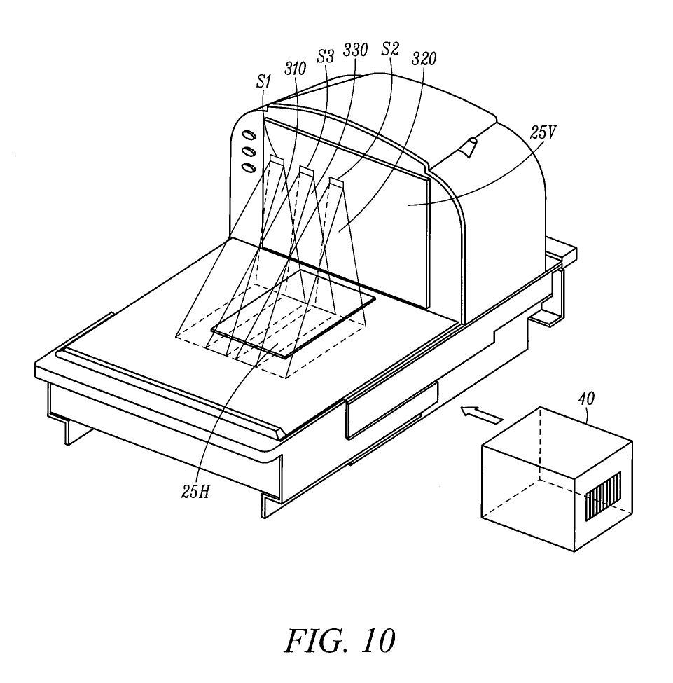

FIGS. 8A and 9A illustrate that the object sensors S1 and S2 can be used to determine the location of an object 40. FIGS. 8B and 9B illustrates that the obtained location of the object of interest can be used by the workstation to selectively turn on one or more of the illumination patterns in one or more predetermined directions.

At a first instant, as shown in FIG. 8A, when the object 40 is moved across the workstation, it may enter the object field of view 320 of the object sensor S2 before entering the object field of view 310 of the object sensor S1. When the workstation recognizes that the object 40 is in the object field of view 320 but this object has not reached the object field of view 310, the workstation can selectively turn on the third illumination pattern 230, as shown in FIG. 8B. In this specific implementation, if only the third illumination pattern 230 is turned on, the risk of exposing the users to the bright light of the illumination patterns may be reduced. As shown in FIG. 8B, the face F4 at the left side of the workstation receives no bright light, because the fourth illumination pattern 240 is not turned on. The face F3 at the right side of the workstation receives little or no bright light, because light from the third illumination pattern 230 is substantially blocked by the object 40.

At a first instant, as shown in FIG. 9A, when the object 40 is moved across the workstation, it may enter the object field of view 310 of the object sensor S1 after leaving the object field of view 320 of the object sensor S2. When the workstation recognizes that the object 40 in the object field of view 310 but this object has left the object field of view 320, the workstation can selectively turn on the fourth illumination pattern 240, as shown in FIG. 9B. In this specific implementation, if only the fourth illumination pattern 240 is turned on, the risk of exposing the users to the bright light of the illumination patterns may be reduced. As shown in FIG. 9B, the face F3 at the right side of the workstation receives no bright light, because the third illumination pattern 230 is not turned on. The face F4 at the left side of the workstation receives little or no bright light, because light from the fourth illumination pattern 240 is substantially blocked by the object 40.

In the implementation as shown in FIGS. 8A-8B, when the object 40 is in the object field of view 320, only the third illumination pattern 230 is turned on. In other implementations, when the object 40 is in the object field of view 320, both the first illumination pattern 210 and the third illumination pattern 230 can be turned on. In these implementations, both the light emitting diodes associated with solid-state imager C1 in FIG. 3A and the light emitting diodes associated with solid-state imager C3 in FIG. 3C can be turned on.

In the implementation as shown in FIGS. 9A-9B, when the object 40 is in the object field of view 310, only the fourth illumination pattern 240 is turned on. In other implementations, when the object 40 is in the object field of view 310, both the second illumination pattern 220 and the fourth illumination pattern 240 can be turned on. In these implementations, both the light emitting diodes associated with solid-state imager C2 in FIG. 3B and the light emitting diodes associated with solid-state imager C4 in FIG. 3D can be turned on.

In the implementation as shown in FIG. 7, the workstation includes two object sensors S1 and S2. In other implementations, the workstation can include three or more object sensors. For example, the workstation in FIG. 10 includes object sensors S1, S2, and S3. Each object sensor is operative to detect the presence of an object within the field of view of the object sensor. As shown in FIG. 10, the object sensor S1 is associated with a object field of view 310, the object sensor S2 is associated with a object field of view 320, and the object sensor S3 is associated with a object field of view 330.

In the implementation as shown in FIGS. 3A-3D, the workstation includes four solid-state imagers, and each solid-state imager has a field of view associated with an illumination pattern. In other implementations, the workstation can have six or more fields of views, and each field of view can be associated with a corresponding illumination pattern. In addition, when the workstation includes three or more object sensors, not only the location information but also other information about the object can be obtained from these object sensors. With more object sensors specially designed and distributed on the workstation, the workstation can make more intelligent decisions on which of the multiple illumination patterns should be turned on at any given time.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus comprising:
a housing including one or more transparent windows and defining a housing interior region;
an imaging system including one or more solid-state imagers, located within the housing interior region, operative to capture light from a plurality of predetermined fields of view;
an illumination system including a plurality of illumination light sources and operative to project illumination patterns in a plurality of predetermined directions;
a plurality of object sensors operative to detect a location of an object relative to at least some of the object sensors, wherein each object sensor is operative to detect the presence of the object within a corresponding field of view of the object sensor; and
electronic circuitry for selectively turning on one or more of the illumination patterns in one or more predetermined directions at least based upon the location of the object obtained with the plurality of object sensors.

2. The apparatus of claim 1, wherein the plurality of object sensors is further operative to estimate the size of the object.

3. The apparatus of claim 1, wherein the housing has one window located in a generally horizontal plane, and another window located in a generally upright plane that intersects the generally horizontal plane.

4. The apparatus of claim 1, wherein a solid-state imager includes a tow-dimensional sensor arrays.

5. The apparatus of claim 1, wherein the plurality of object sensors includes at least two object sensors.

6. The apparatus of claim 1, wherein the plurality of object sensors includes at least three object sensors.

7. The apparatus of claim 1, wherein the electronic circuitry for selectively turning on one or more of the illumination patterns includes:
electronic circuitry for selectively turning on one or more of the illumination patterns in one or more predetermined directions during an exposure period.

8. A method comprising:
detecting a location of an object with a plurality of object sensors each having a corresponding object field of view;
selecting at least one illumination light source to project one or more illumination patterns in one or more predetermined directions at least based upon the location of the object obtained with the plurality of object sensors;
capturing light reflected from a barcode on the object with an imaging system that includes one or more solid-state imagers located within an interior region of a housing having one or more transparent windows; and
processing an image captured by at least one of the solid-state imagers in the imaging system.

9. The method of claim 8, further comprising:
estimating the size of an object with the plurality of object sensors; and
selecting at least one illumination light source to project one or more illumination patterns in one or more predetermined directions based upon the location and the estimated size of the object obtained with the plurality of object sensors;

10. The method of claim 8, wherein the housing has one window located in a generally horizontal plane, and another window located in a generally upright plane that intersects the generally horizontal plane.

11. The method of claim 8, wherein a solid-state imager includes a tow-dimensional sensor arrays.

12. The method of claim 8, wherein the plurality of object sensors includes at least two object sensors.

13. The method of claim 8, wherein the plurality of object sensors includes at least three object sensors.

14. The method of claim 8, wherein the selecting step includes
selecting at least one illumination light source to project one or more illumination patterns in one or more predetermined directions during an exposure period.

15. The method of claim 14, wherein the capturing step includes
capturing light reflected from the barcode on the object with the imaging system during the exposure period.

16. A method comprising:
detecting the presence of an object with a plurality of object sensors each having a corresponding object field of view;
selecting at least one illumination light source to project one or more illumination patterns in one or more predetermined directions based upon at least the location or the size of the object obtained with the plurality of object sensors;
capturing light reflected from a barcode on the object with an imaging system that includes one or more solid-state imagers located within an interior region of a housing having one or more transparent windows; and
processing an image captured by at least one of the solid-state imagers in the imaging system.
